(19) United States
(12) Patent Application Publication
(10) Pub. No.: US 2025/0153643 A1
(43) Pub. Date: May 15, 2025

(54) ELECTRONIC DEVICE FOR DISPLAYING SURROUNDING IMAGES OF VEHICLE IN SPLIT SCREEN AND OPERATING METHOD OF THE SAME

(71) Applicant: THINKWARE CORPORATION, SEONGNAM-SI (KR)

(72) Inventors: Hyun Chul CHO, SEONGNAM-SI (KR); Ho Kwan LEE, SEONGNAM-SI (KR); Sung Rak CHOI, SEONGNAM-SI (KR)

(21) Appl. No.: 18/946,115

(22) Filed: Nov. 13, 2024

(30) Foreign Application Priority Data
Nov. 14, 2023 (KR) 10-2023-0157754
Nov. 27, 2023 (KR) 10-2023-0166563
Nov. 11, 2024 (KR) 10-2024-0158862

(51) Int. Cl. B60R 1/27; G06V 20/58

(52) U.S. Cl. CPC B60R 1/27; G06V 20/58; B60R 2300/20; B60R 2300/70

(57) ABSTRACT

The present disclosure provides an electronic device for displaying surrounding videos of a vehicle in a split screen and an operating method of the same. In the present disclosure, the electronic device is configured to perform a first mode of displaying surrounding videos of the vehicle in a split screen through a digital rear mirror of the vehicle based on a motion related to stopping of the vehicle, and to perform a preset second mode through the digital rear mirror while driving the vehicle. According to some example embodiments, in the first mode, the electronic device may recognize a predetermined object in at least one of the surrounding videos, and may output information on the object while displaying the split screen through the digital rear mirror.

### CROSS-REFERENCE TO RELATED APPLICATION(S)

This application claims the priority benefit under 35 U.S.C. § 119 to Korean Patent Application No. 10-2023-0157754, filed on Nov. 14, 2023, Korean Patent Application No. 10-2023-0166563, filed on Nov. 27, 2023, and Korean Patent Application No. 10-2024-0158862, filed on Nov. 11, 2024, in the Korean Intellectual Property Office, the entire contents of which are incorporated herein by reference in their entirety.

### BACKGROUND

### 1. Field

The present disclosure relates to an electronic device for displaying surrounding videos of a vehicle in a split screen and an operating method of the same.

### 2. Description of Related Art

In general, a driver verifies surroundings of a parked or stopped vehicle before starting the vehicle. This is to prevent a collision between the departing vehicle and an object due to sudden movement of an arbitrary object around the vehicle. In detail, the driver verifies the front of the vehicle through the windshield and verifies the rear of the vehicle through a rear mirror and side mirrors on both sides. That is, the driver verifies the surroundings of the vehicle while moving his or her gaze among the windshield, the rear mirror, and the side mirrors. However, since a gaze movement path for verifying the surroundings of the vehicle is long, there may be a sudden movement of an object around the vehicle even while the driver is moving his or her gaze. Therefore, although the driver verifies the surroundings of the vehicle, a collision between the departing vehicle and an object may occur.

### SUMMARY

The present disclosure relates to an electronic device for minimizing a driver's gaze movement path for verifying surroundings of a parked or stopped vehicle and an operating method of the same.

The present invention provides an electronic device for displaying surrounding videos of a vehicle in a split screen and an operating method of the same.

In the present disclosure, an operating method of an electronic device mounted to a vehicle may include performing a first mode of displaying surrounding videos of the vehicle in a split screen through a digital rear mirror (DRM) of the vehicle based on a motion related to stopping of the vehicle, and performing a preset second mode through the digital rear mirror while driving the vehicle.

According to some example embodiments, the performing of the first mode may include recognizing a predetermined object in at least one of the surrounding videos, and outputting information on the object while displaying the split screen through the digital rear mirror.

In the present disclosure, an electronic device mounted to a vehicle may include a memory, and a processor configured to connect to the memory, and configured to execute at least one instruction stored in the memory, and the processor may be configured to perform a first mode of displaying surrounding videos of the vehicle in a split screen through a digital rear mirror of the vehicle based on a motion related to stopping of the vehicle, and to perform a preset second mode through the digital rear mirror while driving the vehicle.

According to some example embodiments, in the first mode, the processor may be configured to recognize a predetermined object in at least one of the surrounding videos, and to output information on the object while displaying the split screen through the digital rear mirror.

In the present disclosure, a video processing system mounted to a vehicle may include a plurality of camera devices configured to capture surrounding videos of the vehicle, respectively, an electronic device configured to communicatively connect to the camera devices and to process the surrounding videos, and a digital rear mirror configured to communicatively connect to the electronic device and to display video information from the electronic device, and the electronic device may be configured to perform a first mode of displaying surrounding videos of the vehicle in a split screen through the digital rear mirror of the vehicle based on a motion related to stopping of the vehicle, and to perform a preset second mode through the digital rear mirror while driving the vehicle

According to some example embodiments, in the first mode, the electronic device may be configured to recognize a predetermined object in at least one of the surrounding videos, and to output information on the object while displaying the split screen through the digital rear mirror.

According to the present disclosure, an electronic device may display surrounding videos of a vehicle in a split screen through a digital rear mirror based on motion related to stopping or stopping for parking of the vehicle. Therefore, a driver may view all of the surrounding videos of the vehicle through the digital rear mirror. This may minimize the driver's gaze movement path for verifying surroundings of the vehicle. As a result, the driver may effectively detect and quickly avoid even a sudden movement of an arbitrary object around the vehicle. According to some example embodiments, the electronic device may recognize at least one object among surrounding videos and may output information on the object while displaying the split screen. Therefore, the driver may effectively detect and quickly avoid even a sudden movement of an arbitrary object based on information on the object. As described above, the electronic device may promote safety of not only the vehicle and the driver but also a passenger other than the driver.

### BRIEF DESCRIPTION OF THE DRAWINGS

FIG. 1 is a block diagram illustrating a configuration of a video processing system according to various example embodiments.

FIG. 2 is a flowchart illustrating signal flow in a video processing system according to an example embodiment.

FIGS. 3A and 3B illustrate examples for describing operation characteristics of an electronic device according to an example embodiment.

FIG. 4 is a flowchart illustrating signal flow in a video processing system according to another example embodiment.

FIGS. 5A and 5B illustrate examples for describing operation characteristics of an electronic device according to another example embodiment.

FIG. 6 is a block diagram illustrating a configuration of an electronic device according to various example embodiments.

FIG. 7 is a flowchart illustrating an operating method of an electronic device according to various example embodiments.

FIG. 8 is a flowchart illustrating an operation of performing a first mode of an electronic device according to an example embodiment.

FIG. 9 is a flowchart illustrating an operation of performing a first mode of an electronic device according to another example embodiment.

FIG. 10 is a flowchart illustrating an operation of performing a second mode of an electronic device according to various example embodiments.

FIG. 11 is a block diagram illustrating a vehicle to which a video processing system is mounted according to various example embodiments.

FIG. 12 is a block diagram illustrating a control device of the vehicle of FIG. 11.

### DETAILED DESCRIPTION

Hereinafter, various example embodiments of the present document are described with reference to the accompanying drawings.

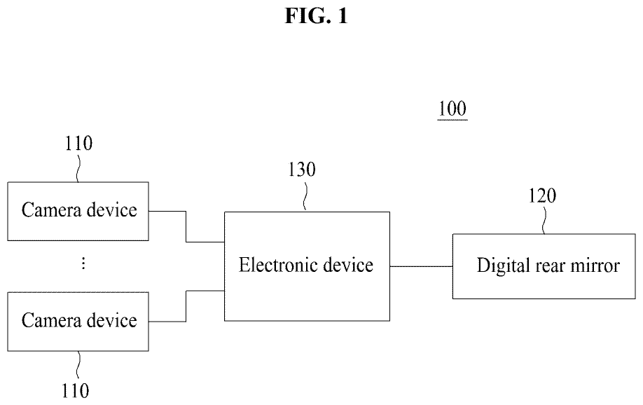

FIG. 1 is a block diagram illustrating a configuration of a video processing system 100 according to various example embodiment.

Referring to FIG. 1, the video processing system 100 may include at least two camera devices 110, a digital rear mirror 120, and an electronic device 130. The video processing system 100 may be mounted to a vehicle. In some example embodiments, at least one another component may be added to the video processing system 100.

Each of the camera devices 110 may acquire video information on a surrounding environment of the vehicle. In some example embodiments, the camera devices 110 may store the video information in an internal memory. In detail, the camera devices 110 may capture surrounding videos of the vehicle. The surrounding videos may include at least two of a front view video, a front-rear view video, a left-rear view video, and a right-rear view video of the vehicle. To this end, the camera devices 110 may be mounted at different locations of the vehicle, respectively.

In some example embodiments, each camera device 110 may include at least one of one or more lenses, an image sensor, a flash, and an image signal processor (ISP). Some of the lenses may have the same lens property (e.g., angle of view, focal distance, autofocus, f number, or optical zoom). The lenses may include a light source lens or a telephoto lens. For example, the image sensor may convert light emitted or reflected from a subject and transmitted through the one or more lenses to an electrical signal, and may acquire an image corresponding to the subject. For example, the image sensors may include, for example, a single image sensor selected from among image sensors with different properties such as a red-green-blue (RGB) sensor, a black and white (BW) sensor, an IF sensor, or an ultraviolet (UV) sensor, a plurality of image sensors with the same property, or a plurality of image sensors with different properties. Each image sensor may be implemented using, for example, a charged coupled device (CCD) sensor or a complementary metal oxide semiconductor (CMOS) sensor. For example, the flash may include one or more light emitting diodes (e.g., RGB LED, white LED, infrared LED, or ultraviolet LED), or a xenon lamp.

The digital rear mirror 120 may provide the view of the vehicle's surrounding environment to a driver of the vehicle. To this end, the digital rear mirror 120 may be provided within the driver's front view range in the vehicle. The digital rear mirror 120 may be in a mirror state or a display state. When in the mirror state, the digital rear mirror 120 may directly illuminate the rear view of the vehicle. When in the display state, the digital rear mirror 120 may display a screen from the electronic device 130 and may provide the view of at least a portion of the vehicle's surrounding environment.

The electronic device 130 may generate a screen using at least a portion of the surrounding videos of the vehicle acquired through the camera devices 110 and may transmit the screen to the digital rear mirror 120. Here, the electronic device 130 may switch between a first mode and a second mode based on a state of the vehicle. To this end, the electronic device 130 may be communicatively connected to each of the vehicle, the camera devices 110, and the digital rear mirror 120 in a wired or wireless manner. Here, the electronic device 130 may be connected to the vehicle through internal network communication (e.g., controller area network (CAN) communication) of the vehicle.

In detail, the electronic device 130 may perform the first mode based on a motion related to stopping of the vehicle. For example, the electronic device 130 may detect the motion related to stopping of the vehicle in the following cases: (i) immediately after the vehicle stops, (ii) if a preset period of time elapses from a point in time at which the vehicle stops, (iii) if the vehicle starts after stopping, (iv) if a speed of the vehicle decreases to be less than a predetermined threshold (e.g., 10 km/h), or (v) if the speed of the vehicle decreases to be less than the threshold and then increases to be greater than or equal to the threshold. In response thereto, the electronic device 130 may execute the first mode. In the first mode, the electronic device 130 may generate the split screen using the surrounding videos of the vehicle. Here, in the split screen, the surrounding videos may be arranged in a preset array. In some example embodiments, the electronic device 130 may recognize an object in at least one of the surrounding videos and may output information on the object when the digital rear mirror 120 displays the split screen. For example, the object may include at least one of a person, a thing, a thing approaching the vehicle, and a thing moving away from the vehicle. Here, information on the object may include at least one of the object's type, size, speed, and distance from the vehicle.

Meanwhile, the electronic device 130 may perform the second mode while driving the vehicle. For example, if the vehicle starts, if a preset speed (e.g., 10 km/h) is reached after starting the vehicle, or if a preset period of time elapses after starting the vehicle, the electronic device 130 may detect the same as a motion related to driving start of the vehicle and may execute the second mode in response thereto. The second mode may be preset and, for example, may be set by the user or by default. In the second mode, the electronic device 130 may drive the digital rear mirror 120 in the mirror state or may generate the screen using at least one surrounding video of the vehicle.

In some example embodiments, each camera device 110 and the electronic device 130 may be connected through a communication cable. In an example embodiment, the camera device 110 and the electronic device 130 may perform communication using an analog method. The analog method may include, for example, analogue high definition (AHD). In another example embodiment, the camera device 110 and the electronic device 130 may perform communication using a digital method. For example, the digital method may include a serial transmission method. In this case, the camera device 110 may include a serializer, and the electronic device 130 may include a deserializer. However, without being limited thereto, the camera device 110 and the electronic device 130 may be connected through internal network communication (e.g., controller area network (CAN) communication) of the vehicle. The camera device 110 and the electronic device 130 may include various communication chips.

In an example embodiment, the digital rear mirror 120 and the electronic device 130 may be integrally configured. In this case, the electronic device 130 may be provided within the driver's front view range in the vehicle with the digital rear mirror 120. In another example embodiment, the digital rear mirror 120 and the electronic device 130 may be separately configured. In this case, the digital rear mirror 120 may be provided within the driver's front view range in the vehicle, and the electronic device 130 may be provided at a separate location in the vehicle.

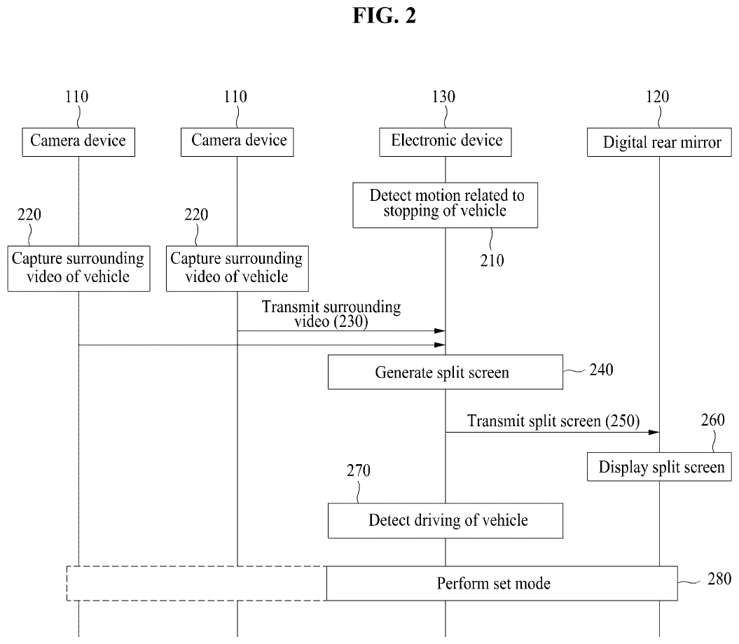

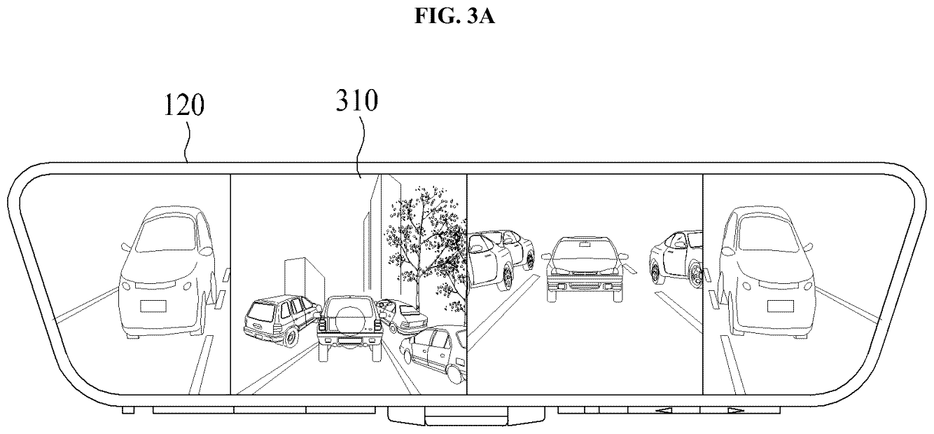

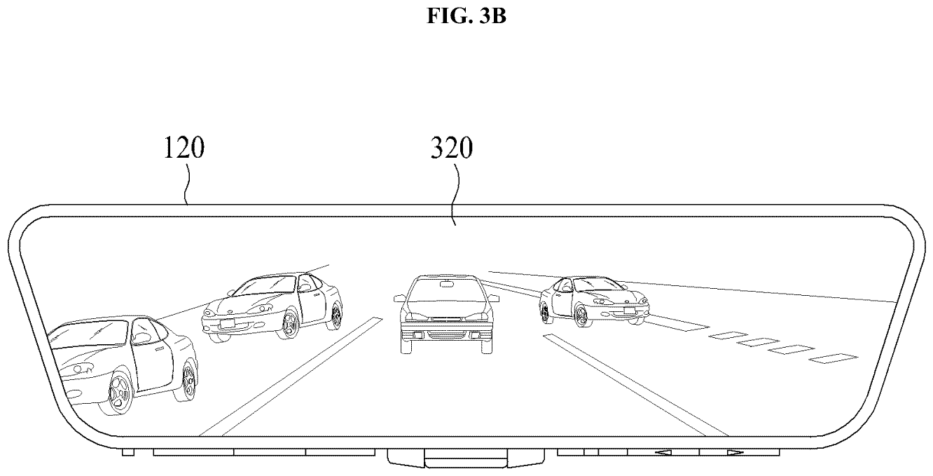

FIG. 2 is a flowchart illustrating signal flow in the video processing system 100 according to an example embodiment. FIGS. 3A and 3B illustrate examples for describing operation characteristics of the electronic device 130 according to an example embodiment.

Referring to FIG. 2, in operation 210, the electronic device 130 may detect a motion related to stopping of the vehicle. For example, the electronic device 130 may detect the motion related to stopping of the vehicle in the following cases: (i) immediately after the vehicle stops, (ii) if a preset period of time elapses from a point in time at which the vehicle stops, (iii) if the vehicle starts after stopping, (iv) if a speed of the vehicle decreases to be less than a predetermined threshold (e.g., 10 km/h), or (v) if the speed of the vehicle decreases to be less than the threshold and then increases to be greater than or equal to the threshold. In response thereto, the electronic device 130 may execute the first mode. Here, if the digital rear mirror 120 is in the mirror state, the electronic device 130 may drive the digital rear mirror 120 in the display state. If the digital rear mirror 120 is in the display state, the electronic device 130 may maintain the digital rear mirror 120. Therefore, the electronic device 130 may perform the first mode based on the motion related to stopping of the vehicle.

Then, in operation 220, the camera devices 110 may capture surrounding videos of the vehicle, respectively. The surrounding videos may include at least two of a front view video, a front-rear view video, a left-rear view video, and a right-rear view video of the vehicle. Then, in operation 230, the camera devices 110 may transmit the surrounding videos to the electronic device 130, respectively. Therefore, the electronic device 130 may acquire the surrounding videos through the camera devices 110 in the first mode.

Then, in operation 240, the electronic device 130 may generate a split screen 310 using the surrounding videos. In the first mode, the electronic device 130 may generate the split screen 310 as shown in FIG. 3A, using the surrounding videos of the vehicle. Here, in the split screen 310, the surrounding videos may be arranged in a preset array. Then, in operation 250, the electronic device 130 may transmit the split screen 310 to the digital rear mirror 120. Therefore, in operation 260, the digital rear mirror 120 may display the split screen 310. Therefore, in the first mode, the electronic device 130 may display the split screen 310 through the digital rear mirror 120 as shown in FIG. 3A. FIG. 3A illustrates an example in which the left-rear view video, the front view video, the front-rear view video, and the right-rear view video of the vehicle are arranged from the left to the right of the split screen 310. However, without being limited thereto, the split screen 310 may be configured using various combinations and various arrangements of the surrounding videos.

Meanwhile, in operation 270, the electronic device 130 may detect driving of the vehicle. For example, if the vehicle starts, if a preset speed (e.g., 10 km/h) is reached after starting the vehicle, or if a preset period of time elapses after starting the vehicle, the electronic device 130 may detect the same as a motion related to driving start of the vehicle and may execute the second mode in response thereto. The second mode may be preset and, for example, may be set by the user or by default. Therefore, the electronic device 130 may perform the second mode while driving the vehicle.

Then, in operation 280, the electronic device 130 may perform a set mode, that is, the second mode. In the second mode, the electronic device 130 may drive the digital rear mirror 120 in a mirror state. Alternatively, in the second mode, the electronic device 130 may display a screen 320 for at least one surrounding video of the vehicle through the digital rear mirror 120 as shown in FIG. 3B. According to settings, the second mode and the first mode may be the same or differ from each together. For example, in the same manner as operations 220 to 260, the electronic device 130 may acquire all surrounding videos through the camera devices 110, and may display the corresponding surrounding videos in the split screen through the digital rear mirror 120. As another example, the electronic device 130 may acquire a single surrounding video through one of the camera devices 110 and may display the single surrounding video in a single screen through the digital rear mirror 120. As another example, the electronic device 130 may acquire at least two surrounding videos through some of the camera devices 110 and may display the corresponding surrounding videos in the split screen through the digital rear mirror 120. FIG. 3B illustrates an example in which the screen 320 is configured as a rear view video of the vehicle. However, without being limited thereto, the screen 320 may be configured using various combinations and various arrangements of the surrounding videos.

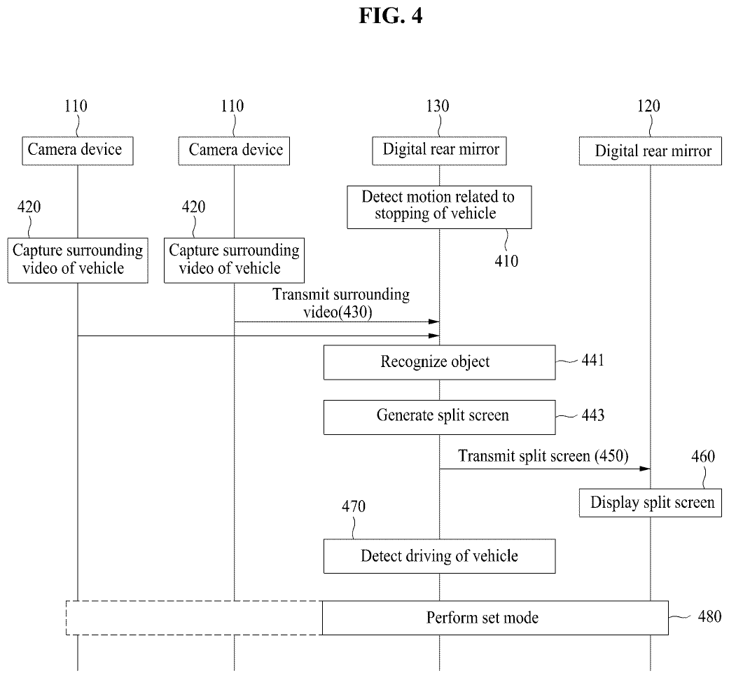

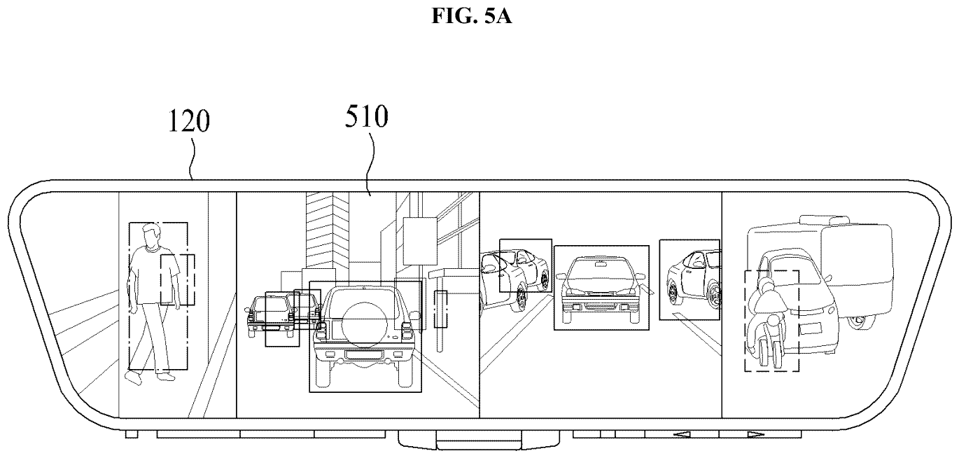

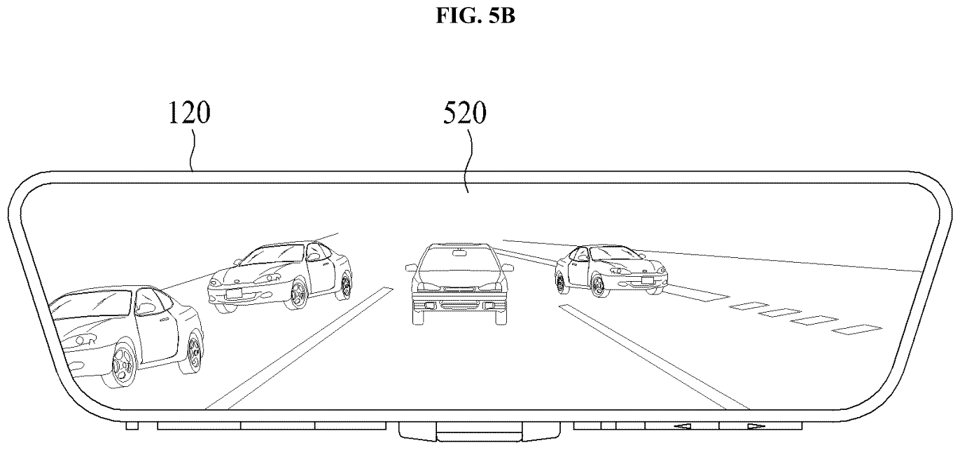

FIG. 4 is a flowchart illustrating signal flow in the video processing system 100 according to another example embodiment. FIGS. 5A and 5B illustrate examples for describing operation characteristics of the electronic device 130 according to another example embodiment.

Referring to FIG. 4, in operation 410, the electronic device 130 may detect a motion related to stopping of the vehicle. For example, the electronic device 130 may detect the motion related to stopping of the vehicle in the following cases: (i) immediately after the vehicle stops, (ii) if a preset period of time elapses from a point in time at which the vehicle stops, (iii) if the vehicle starts after stopping, (iv) if a speed of the vehicle decreases to be less than a predetermined threshold (e.g., 10 km/h), or (v) if the speed of the vehicle decreases to be less than the threshold and then increases to be greater than or equal to the threshold. In response thereto, the electronic device 130 may execute the first mode. Here, if the digital rear mirror 120 is in a mirror state, the electronic device 130 may display the digital rear mirror 120 in a display state. If the digital rear mirror 120 is in the display state, the electronic device 130 may maintain the digital rear mirror 120. Therefore, the electronic device 130 may perform the first mode based on the motion related to stopping of the vehicle.

Then, in operation 420, the camera devices 110 may capture surrounding videos of the vehicle, respectively. The surrounding videos may include at least two of a front view video, a front-rear view video, a left-rear view video, and a right-rear view video of the vehicle. Then, in operation 430, the camera devices 110 may transmit the surrounding videos to the electronic device 130, respectively. Therefore, the electronic device 130 may acquire the surrounding videos through the camera devices 110 in the first mode.

Then, in operation 441, the electronic device 130 may recognize an object in at least one of the surrounding videos. For example, the object may include at least one of a person, a thing, a thing approaching the vehicle, and a thing moving away from the vehicle. Here, the electronic device 130 may verify information on the object. Here, information on the object may include at least one of the object's type, size, speed, and distance from the vehicle. Then, in operation 443, the electronic device 130 may generate a split screen 510 using the surrounding videos. In the first mode, the electronic device 130 may generate the split screen 510 as shown in FIG. 5A, using the surrounding videos of the vehicle. Here, the surrounding videos may be arranged in a preset array in the split screen 510. For example, the electronic device 130 may express an indicator representing information on the object within the split screen 510. Then, in operation 450, the electronic device 130 may transmit the split screen 510 to the digital rear mirror 120. Therefore, in operation 460, the digital rear mirror 120 may display the split screen 510. Therefore, as shown in FIG. 5A, in the first mode, the electronic device 130 may display the split screen 510 through the digital rear mirror 120. For example, as the indicator is expressed in the split screen 510, the electronic device 130 may display information on the object through the digital rear mirror 120. As another example, the electronic device 130 may output information on the object as an audio signal on its own or through the digital rear mirror 120. As another example, the electronic device 130 may output information on the object as an audio signal on its own or through the digital rear mirror 120, while displaying information on the object through the digital rear mirror 120.

Meanwhile, in operation 470, the electronic device 130 may detect driving of the vehicle. For example, if the vehicle starts, if a preset speed (e.g., 10 km/h) is reached after starting the vehicle, or if a preset period of time elapses after starting the vehicle, the electronic device 130 may detect the same as a motion related to driving start of the vehicle and may execute the second mode in response thereto. The second mode may be preset and, for example, may be set by the user or by default. Therefore, the electronic device 130 may perform the second mode while driving the vehicle.

Then, in operation 480, the electronic device 130 may perform a preset model, that is, the second mode. In the second mode, the electronic device 130 may drive the digital rear mirror 120 in the mirror state. Alternatively, as shown in FIG. 5B, in the second mode, the electronic device 130 may display a screen 520 for at least one surrounding video of the vehicle through the digital rear mirror 120. According to settings, the second mode and the first mode may be the same or differ from each other. For example, in the same manner as operations 420 to 460, the electronic device 130 may acquire all surrounding videos through the camera devices 110, and may display the corresponding surrounding videos in the split screen through the digital rear mirror 120. As another example, the electronic device 130 may acquire a single surrounding video through one of the camera devices 110 and may display the single surrounding video in a single screen through the digital rear mirror 120. As another example, the electronic device 130 may acquire at least two surrounding videos through some of the camera devices 110 and may display the corresponding surrounding videos in the split screen through the digital rear mirror 120.

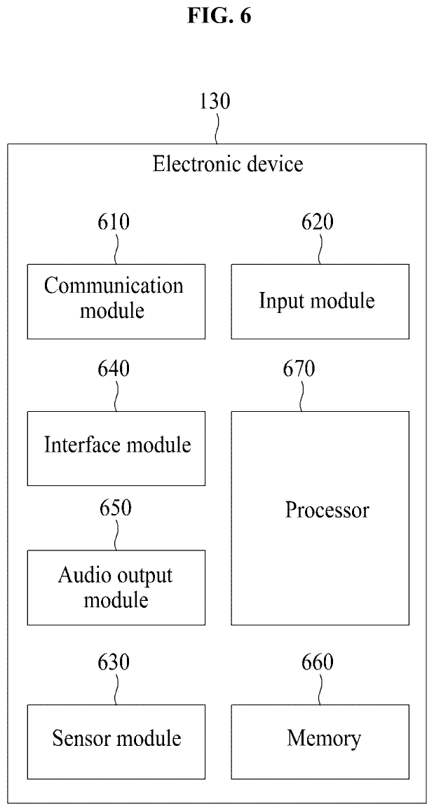

FIG. 6 is a block diagram illustrating a configuration of the electronic device 130 according to various example embodiments.

Referring to FIG. 6, the electronic device 130 may include at least one of a communication module 610, an input module 620, a sensor module 630, an interface module 640, an audio output module 650, a memory 660, and a processor 670. The electronic device 130 may be mounted to the vehicle with the camera device 110 and the digital rear mirror 120, and may be communicatively connected to each of the vehicle, the camera devices 110, and the digital rear mirror 120 in a wired or wireless manner. In some example embodiments, at least one component (e.g., communication module, sensor module) among components of the electronic device 130 may be omitted and at least one another component (e.g., display module) may be added. In some example embodiments, at least two of the components of the electronic device 130 may be implemented as a single integrated circuit. In an example embodiment, the components of the electronic device 130 may be integrally configured as a single unit. In this case, the components of the electronic device 130 may be accommodated within a single housing. In another example embodiment, the components of the electronic device 130 may be configured through distribution into at least two units.

The communication module 610 may perform communication between the electronic device 130 and an external device. The communication module 610 may establish a communication channel with the external device and may communicate with the external device through the communication channel. Here, the external device may include at least one of a satellite, a base station, a server, and another electronic device (e.g., used by the driver). The communication module 610 may include at least one of a wired communication module and a wireless communication module. The wired communication module may be connected to the external device in a wired manner and may perform communication in the wired manner. The wireless communication module may include at least one of a near field communication module and a far field communication module. The near field communication module may communicate with the external device using a near field communication scheme. For example, the near field communication scheme may include at least one of Bluetooth, wireless fidelity (WiFi) direct, near field communication (NFC), and infrared data association (IrDA). The far field communication module may communicate with the external device using a far field communication scheme. Here, the far field communication module may communicate with the external device over a network. For example, the network may include at least one of a cellular network, the Internet, and a computer network such as a local area network (LAN) and a wide area network (WAN).

The input module 620 may input a signal to be used for at least one component of the electronic device 130. The input module 620 may include, for example, at least one of at least one button (also, referable to as key), a keyboard, a keypad, a mouse, a joystick, and a microphone. Here, the button may include at least one of a physical button and a touch button. In some example embodiments, the input module 620 may include at least one of a touch circuitry set to detect a touch and a sensor circuitry set to measure strength of force generated by the touch. In some example embodiments, when the electronic device 130 is integrally configured with the digital rear mirror 120, a touchscreen may be implemented in such a manner that the touch circuitry or the sensor is combined with the digital rear mirror 120.

The sensor module 630 may generate an electrical signal or a data value corresponding to an internal operation state (e.g., power or temperature) of the electronic device 130 or an external environmental state. For example, the sensor module 630 may include at least one of a global positioning system (GPS) sensor, a motion sensor (also, referable as a gesture sensor), a proximity sensor, a touch sensor, a radar sensor, a light detection and ranging (LIDAR) sensor, a movement sensor, a gyro sensor, a barometric pressure sensor, a magnetic sensor, an acceleration sensor (e.g., G sensor), a proximity sensor, an infrared (IR) sensor, a biosignal sensor, a temperature sensor, a humidity sensor, and an illuminance sensor.

According to various example embodiments, at least one of the communication module 610, the input module 620, and the sensor module 630 may generate a user input. In an example embodiment, the input module 620 or an arbitrary sensor of the sensor module 630 may generate the user input based on a signal that is directly input from the user. In another example embodiment, the communication module 610 may generate the user input based on a signal that is input from an electronic device used by the user.

The interface module 640 may be provided for interfacing between the electronic device 130 and the external device. In detail, the interface module 640 may support a designated protocol that may be connected to the external device in a wired or wireless manner. Here, the external device may include at least one of the vehicle, the camera devices 110, and the digital rear mirror 120. In an example embodiment, in the case of communicating with each camera device 110 using an analog method, the interface module 640 may receive video information from the camera device 110 and may convert the video information from an analog signal to digital data. In another example embodiment, in the case of communicating with the camera device 110 using a digital method, the interface module 640 may receive the video information from the camera device 110 and may convert the same from serial data to parallel data. In this case, the interface module 640 may be implemented as a deserializer.

The audio output module 650 may output an audio signal to the outside of the electronic device 130. For example, the audio output module 650 may include at least one of a speaker and a receiver. In an example embodiment, the audio output module 650 may include at least one voice coil that provides vibration to a diaphragm within the speaker and a magnet capable of forming a magnetic field. When current flows in the voice coil, the magnetic field formed in the voice coil may vibrate the voice coil through interaction with the magnetic field formed by the magnet. The diaphragm connected to the voice coil may vibrate based on vibration of the voice coil. The speaker may output the audio signal based on the vibration of the diaphragm.

The memory 660 may store a variety of data used by at least one component of the electronic device 130. For example, the memory 660 may include at least one of a volatile memory and a non-volatile memory. Data may include at least one program and input data or output data related thereto. The program may be stored in the memory 660 as software including at least one instruction, and, for example, may include at least one of an operating system (OS), middleware, and an application. The memory 660 may include at least one of a first memory embedded in the electronic device 130 and a second memory detachably provided to the electronic device 130.

The processor 670 may control at least one component of the electronic device 130. Through this, the processor 670 may perform data processing or operation. For example, hardware for processing data may include an arithmetic and logic unit (ALU), a floating point unit (FPU), a field programmable gate array (FPGA), a central processing unit (CPU), and/or an application processor (AP). The processor 670 may have a structure of a single-core processor or may have a structure of a multi-core processor, such as dual core, quad core, hexa core, and octa core. The processor 670 may execute the instruction stored in the memory 660. According to various example embodiments, the processor 670 may generate a screen using at least some of the surrounding videos of the vehicle acquired through the camera devices 110, and may transmit the screen to the digital rear mirror 120. Here, the, processor 670 may switch between the first mode and the second mode based on a state of the vehicle.

In detail, the processor 670 may perform the first mode based on a motion related to stopping of the vehicle. For example, the processor 670 may detect the motion related to stopping of the vehicle in the following cases: (i) immediately after the vehicle stops, (ii) if a preset period of time elapses from a point in time at which the vehicle stops, (iii) if the vehicle starts after stopping, (iv) if a speed of the vehicle decreases to be less than a predetermined threshold (e.g., 10 km/h), or (v) if the speed of the vehicle decreases to be less than the threshold and then increases to be greater than or equal to the threshold. In response thereto, the processor 670 may execute the first mode. In the first mode, the processor 670 may generate a split screen using the surrounding videos of the vehicle. Here, in the split screen, the surrounding videos may be arranged in a preset array. In some example embodiments, the processor 670 may recognize an object in at least one of the surrounding videos and may output information on the object when the digital rear mirror 120 displays the split screen. For example, the object may include at least one of a person, a thing, a thing approaching the vehicle, and a thing moving away from the vehicle. Here, information on the object may include at least one of the object's type, size, speed, and distance from the vehicle.

Meanwhile, the processor 670 may perform the second mode while driving the vehicle. For example, if the vehicle starts, if a preset speed (e.g., 10 km/h) is reached after starting the vehicle, or if a preset period of time elapses after starting the vehicle, the processor 670 may detect the same as a motion related to driving start of the vehicle and may execute the second mode in response thereto. The second mode may be preset and, for example, may be set by the user or by default. In the second mode, the processor 670 may drive the digital rear mirror 120 in the mirror state or may generate the screen using at least one surrounding video of the vehicle.

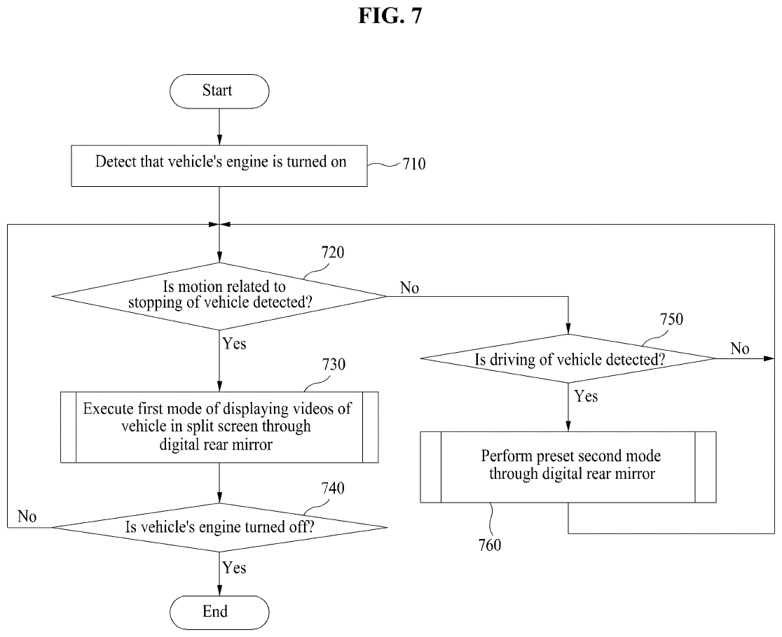

FIG. 7 is a flowchart illustrating an operating method of the electronic device 130 according to various example embodiments.

Referring to FIG. 7, in operation 710, the electronic device 130 may detect that the vehicle's engine is turned on. Here, the interface module 640 may be communicatively connected to the vehicle in a wired or wireless manner. Here, the interface module 640 may be connected to the vehicle through internal network communication (e.g., CAN communication) of the vehicle. Therefore, the processor 670 may detect that the vehicle's engine is turned on through the interface module 640. In a state in which the vehicle's engine is turned on, the processor 670 may continuously receive state information of the vehicle through the interface module 640. Here, the state information may include at least one of speed information of the vehicle, operation information of a brake pedal, operation information of an accelerator pedal, and location information of the vehicle.

Then, in operation 720, the electronic device 130 may detect a motion related to stopping of the vehicle. In detail, the processor 670 may detect the motion related to stopping of the vehicle using state information of the vehicle. Here, the motion related to stopping of the vehicle may represent actual stopping of the vehicle and may not represent actual stopping of the vehicle. For example, the processor 670 may detect the motion related to stopping of the vehicle in the following cases: (i) immediately after the vehicle stops, (ii) if a preset period of time elapses from a point in time at which the vehicle stops, (iii) if the vehicle starts after stopping, (iv) if a speed of the vehicle decreases to be less than a predetermined threshold (e.g., 10 km/h), or (v) if the speed of the vehicle decreases to be less than the threshold and then increases to be greater than or equal to the threshold.

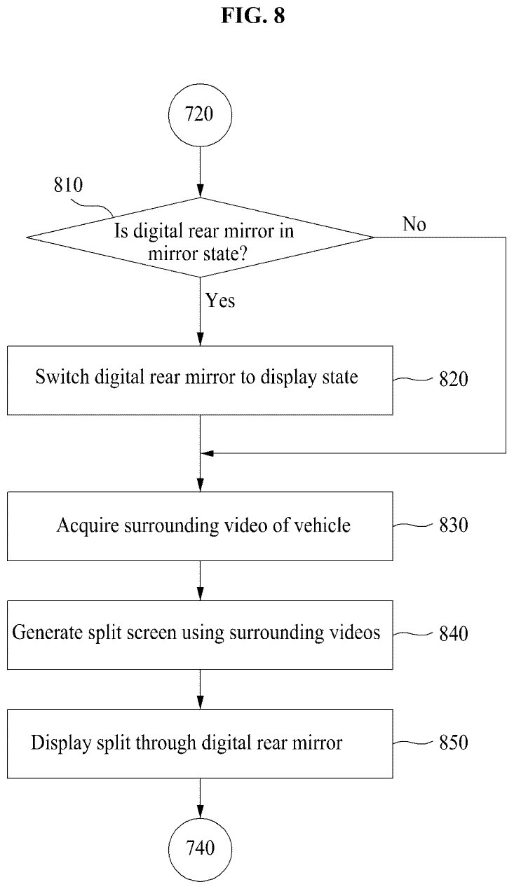

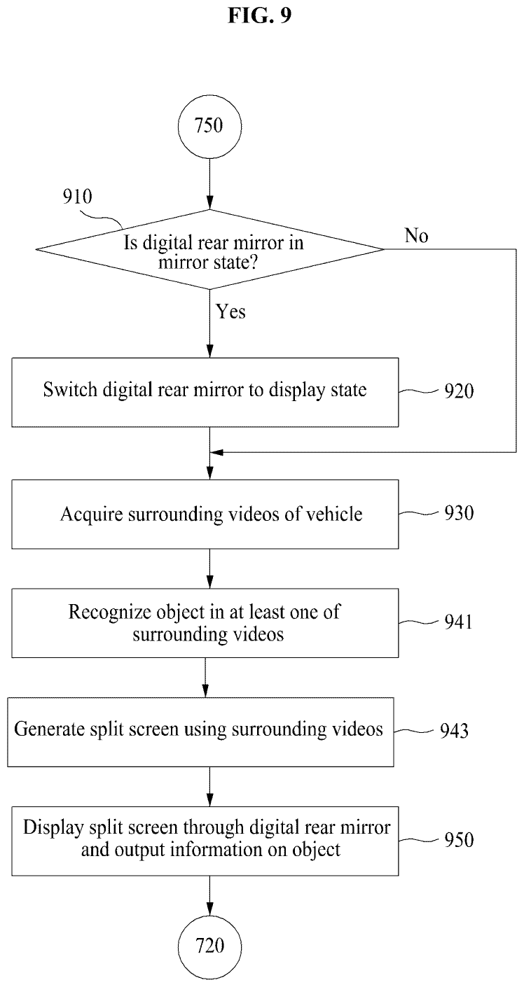

In response thereto, in operation 730, the electronic device 130 may execute the first mode. In detail, in the first mode, the processor 670 may display the surrounding videos of the vehicle in the split screen 310, 510 through the digital rear mirror 120. Further description related thereto is made with reference to FIGS. 8 and 9. The processor 670 may repeatedly perform the first model until the vehicle's engine is detected to turned off in operation 740 or until driving of the vehicle is detected in operation 750.

FIG. 8 is a flowchart illustrating an operation (operation 730) of performing the first mode of the electronic device 130 according to an example embodiment.

Referring to FIG. 8, in operation 810, the electronic device 130 may determine whether the digital rear mirror 120 is in a mirror state. In detail, the processor 130 may determine whether the digital rear mirror 120 is in the mirror state or in a display state. Then, if it is determined that the digital rear mirror 120 is in the mirror state, the electronic device 130 may switch the digital rear mirror 120 to the display state in operation 820. Here, the interface module 640 may be communicatively connected to the digital rear mirror 120 in a wired or wireless manner. In detail, if the digital rear mirror 120 is in the mirror state, the processor 670 may drive the digital rear mirror 120 in the display state through the interface module 640. If the digital rear mirror 120 is in the display state, the processor 670 may maintain the digital rear mirror 120.

Then, in operation 830, the electronic device 130 may acquire surrounding videos of the vehicle. Here, the interface module 640 may be communicatively connected to each of the camera devices 110 in a wired or wireless manner. The camera devices 110 may capture the surrounding videos of the vehicle, respectively. The surrounding videos may include at least two of a front view video, a front-rear view video, a left-rear view video, and a right-rear view video of the vehicle. The camera devices 110 may transmit the surrounding videos to the electronic device 130, respectively. Therefore, the processor 670 may receive the surrounding videos from the camera devices 110, respectively, through the interface module 640.

Then, in operation 840, the electronic device 130 may generate the split screen 310 using the surrounding videos. In detail, as shown in FIG. 3A, the processor 670 may generate the split screen 310 using the surrounding videos of the vehicle. Here, the surrounding videos may be arranged in a preset array in the split screen 310. FIG. 3A illustrates an example in which the left-rear view video, the front view video, the front-rear view video, and the right-rear view video of the vehicle are arranged from the left to the right of the split screen 310. However, without being limited thereto, the split screen 310 may be configured using various combinations and various arrangements of the surrounding videos.

Then, in operation 850, the electronic device 130 may display the split screen 310 through the digital rear mirror 120. In detail, the processor 670 may transmit the split screen 310 to the digital rear mirror 120 through the interface module 640. Therefore, as shown in FIG. 3A, the digital rear mirror 120 may display the split screen 310 in the display state. Selectively or additionally, the processor 670 may partially enlarge the split screen 310 while displaying the split screen 310. For example, the processor 670 may select one of the surrounding videos in the split screen 310 based on a user input and may enlarge the selected surrounding video. As another example, the processor 670 may select a partial area of the split screen 310 based on the user input and may enlarge the selected area. Here, the processor 670 may detect the user input through at least one of the communication module 610, the input module 620, and the sensor module 630.

FIG. 9 is a flowchart illustrating an operation (operation 730) of performing the first mode of the electronic device 130 according to another example embodiment.

Referring to FIG. 9, in operation 910, the electronic device 130 may determine whether the digital rear mirror 120 is in the mirror state. In detail, the processor 130 may determine whether the digital rear mirror 120 is in the mirror state or in the display state. Then, if it is determined that the digital rear mirror 120 is in the mirror state, the electronic device 130 may switch the digital rear mirror 120 to the display state in operation 920. Here, the interface module 640 may be communicatively connected to the digital rear mirror 120 in a wired or wireless manner. In detail, if the digital rear mirror 120 is in the mirror state, the processor 670 may drive the digital rear mirror 120 in the display state through the interface module 640. If the digital rear mirror 120 is in the display state, the processor 670 may maintain the digital rear mirror 120.

Then, in operation 930, the electronic device 130 may acquire the surrounding videos of the vehicle. Here, the interface module 640 may be communicatively connected to each of the camera devices 110 in a wired or wireless manner. The camera devices 110 may capture the surrounding videos of the vehicle, respectively. The surrounding videos may include at least two of the front view video, the front-rear view video, the left-rear view video, and the right-rear view video of the vehicle. The camera devices 110 may transmit the surrounding videos to the electronic device 130, respectively. Therefore, the processor 670 may receive the surrounding videos from the camera devices 110, respectively, through the interface module 640.

Then, in operation 941, the electronic device 130 may recognize an object in at least one of the surrounding videos. In detail, the processor 670 may include an artificial intelligence (AI) algorithm for object recognition and may recognize an object in at least one of the surrounding videos using the AI algorithm. For example, the object may include at least one of a person, a thing, a thing approaching the vehicle, and a thing moving away from the vehicle. Here, the processor 670 may verify information on the object. Here, information on the object may include at least one of the object's type, size, speed, and distance from the vehicle.

Then, in operation 943, the electronic device 130 may generate the split screen 510 using the surrounding videos. In detail, as shown in FIG. 5A, the processor 670 may generate the split screen 510 using the surrounding videos of the vehicle. Here, the surrounding videos may be arranged in a preset array in the split screen 510. FIG. 5A illustrates an example in which the left-rear view video, the front view video, the front-rear view video, and the right-rear view video of the vehicle are arranged from the left to the right of the split screen 510. However, without being limited thereto, the split screen 510 may be configured using various combinations and various arrangements of the surrounding videos. For example, the processor 670 may express an indicator representing information on the object within the split screen 510. Here, the indicator may be expressed as at least one of text, frame, color, figure, and symbol.

Then, in operation 950, the electronic device 130 may display the split screen 510 through the digital rear mirror 120. In detail, the processor 670 may transmit the split screen 510 to the digital rear mirror 120 through the interface module 640. Therefore, as shown in FIG. 5A, the digital rear mirror 120 may display the split screen 510 in the display state. For example, as the indicator is expressed in the split screen 510, the processor 670 may display information on the object through the digital rear mirror 120. As another example, the processor 670 may output information on the object as an audio signal through the audio output module 650 or the digital rear mirror 120. As another example, the processor 670 may output information on the object as an audio signal through the audio output module 650 or the digital rear mirror 120 while displaying information on the object through the digital rear mirror 120. Selectively or additionally, the processor 670 may partially enlarge the split screen 510 while displaying the split screen 510. For example, the processor 670 may select one of the surrounding videos in the split screen 510 based on the user input and may enlarge the selected surrounding video. As another example, the processor 670 may select a partial area of the split screen 510 based on the user input and may enlarge the selected area. Here, the processor 670 may detect the user input through at least one of the communication module 610, the input module 620, and the sensor module 630.

Referring again to FIG. 7, in operation 740, the electronic device 130 may detect that the vehicle's engine is turned off. In detail, while performing the first mode in operation 730, the processor 670 may detect that the vehicle's engine is turned off in operation 740. The processor 670 may detect that the vehicle's engine is turned off through the interface module 640. In this case, the electronic device 130 may terminate the first mode. Meanwhile, unless the vehicle's is detected to be turned off in operation 740, the electronic device 130 may return to operation 720.

Meanwhile, in operation 750, the electronic device 130 may detect driving of the vehicle. That is, in a state in which the vehicle's engine is turned on, the motion related to stopping of the vehicle may not be detected in operation 720 and driving of the vehicle may be detected in operation 730. In detail, the processor 670 may detect driving of the vehicle using state information of the vehicle. Here, driving of the vehicle may represent actual, that is, continuous driving of the vehicle and may also represent discontinuous driving including temporary stopping of the vehicle. For example, if the vehicle starts, if a preset speed (e.g., 10 km/h) is reached after starting the vehicle, or if a preset period of time elapses after starting the vehicle, the processor 670 may detect the same as the motion related to driving start of the vehicle and may execute the second mode in response thereto.

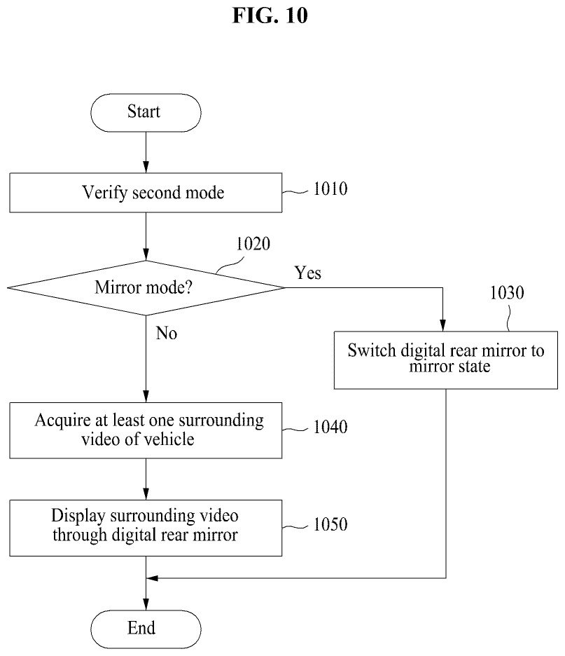

In response thereto, in operation 760, the electronic device 130 may perform the second mode. The second mode may be preset and, for example, may be set by the user or by default. In detail, in the second mode, the processor 670 may drive the digital rear mirror 120 in the mirror state. Alternatively, as shown in FIG. 5B, in the second mode, the processor 670 may display the screen 520 for at least one surrounding video of the vehicle through the digital rear mirror 120. According to settings, the second mode and the first mode may be the same or may differ from each together. Furth description related thereto is made below with reference to FIG. 10. The processor 670 may repeatedly perform the second mode until the motion related to stopping of the vehicle is detected in operation 720.

FIG. 10 is a flowchart illustrating an operation (operation 760) of performing the second mode of the electronic device 130 according to various example embodiments.

Referring to FIG. 10, in operation 1010, the electronic device 130 may verify the second mode. In detail, the processor 670 may verify contents set as the second mode.

Then, in operation 1020, the electronic device 130 may determine whether the second mode is set to a mirror mode. In detail, the processor 670 may verify whether the second mode is set to the mirror mode or to a display mode of a specific method. Then, if it is determined that the second mode is set to the mirror mode, the electronic device 130 may switch the digital rear mirror 120 to the mirror state in operation 1030. In detail, if the second mode is set to the mirror mode, the processor 670 may drive the digital rear mirror 120 in the mirror state through the interface module 640. Therefore, if the second mode is set to the mirror mode, the digital rear mirror 120 may directly illuminate the rear view of the vehicle in the mirror state.

Meanwhile, if it is determined that the second mode is not set to the mirror mode, the electronic device 130 may acquire at least one surrounding video of the vehicle in operation 1040. In detail, if the second mode is set to the display mode, the processor 670 may maintain the digital rear mirror 120. The processor 670 may acquire at least one surrounding video through the interface module 640. Here, in response to settings in the second mode, the processor 670 may select at least one from among the camera devices 110 and may acquire at least one surrounding video through the at least one camera device 110. The at least one surrounding video may be at least one of a front view video, a front-rear view video, a left-rear view video, and a right-rear view video of the vehicle. At least one camera device 110 may transmit at least one surrounding video to the electronic device 130. Therefore, the processor 670 may receive at least one surrounding video from at least one camera device 110 through the interface module 640.

Then, in operation 1050, the electronic device 130 may display at least one surrounding video through the digital rear mirror 120. In detail, using at least one surrounding video, the processor 670 may generate the screens 320 and 520 as shown in FIGS. 3B and 5B. Then, the processor 670 may transmit the screens 320 and 520 to the digital rear mirror 120 through the interface module 640. Therefore, as shown in FIGS. 3B and 5B, the digital rear mirror 120 may display the screens 320 and 520 in the display state. FIGS. 3B and 5B illustrate examples in which the screens 320 and 520 include a single surrounding video. However, without being limited thereto, the screen 320, 520 may be configured using various combinations and various arrangements of the surrounding videos. Selectively or additionally, while displaying the screen 320, 520, the processor 670 may partially enlarge the screen 320, 520. For example, the processor 670 may select one of the surrounding videos in the screen 320, 520 based on the user input and may enlarge the selected surrounding video. As another example, the processor 670 may select a partial area of the screen 320, 520 based on the user input and may enlarge the selected area. Here, the processor 670 may detect the user input through at least one of the communication module 610, the input module 620, and the sensor module 630.

For example, when the second mode and the first mode are the same, the processor 670 may acquire all surrounding videos through the camera devices 110 and may display the corresponding surrounding videos in the split screen through the digital rear mirror 120. As another example, the processor 670 may acquire a single surrounding video through one of the camera devices 110 and may display the single surrounding video in a single screen through the digital rear mirror 120. As another example, the processor 670 may acquire at least two surrounding videos through some of the camera devices 110 and may display the corresponding surrounding videos in the split screen through the digital rear mirror 120.

According to the present disclosure, the electronic device 130 may display surrounding videos of the vehicle in the split screen 310, 510 through the digital rear mirror 120 based on the motion related to stopping or stopping for parking of the vehicle. Therefore, the driver may view all the surrounding videos of the vehicle through the digital rear mirror 120. This may minimize the driver's gaze movement path for verifying surroundings of the vehicle and, as a result, the driver may effectively detect and quickly avoid even a sudden movement of an arbitrary object around the vehicle. According to some example embodiments, the electronic device 130 may recognize an object in at least one of the surrounding videos, and may output information on the object while displaying the split screen 310, 510. Therefore, the driver may effectively detect and quickly avoid even a sudden movement of an arbitrary object based on information on the object. As described above, the electronic device 130 may promote safety of not only the vehicle and the driver but also a passenger other than the driver.

In short, the present disclosure provides the electronic device 130 for displaying surrounding videos of the vehicle in the split screen 310, 510 and an operating method of the same.

In the present disclosure, an operating method of the electronic device 130 mounted to the vehicle may include performing a first mode of displaying surrounding videos of the vehicle in the split screen 310, 510 through the digital rear mirror 120 of the vehicle based on a motion related to stopping of the vehicle (operation 720) (operation 730), and performing a preset second mode through the digital rear mirror 120 while driving the vehicle (operation 750) (operation 760).

According to various example embodiments, the surrounding videos may include at least two of a front view video, a front-rear view video, a left-rear view video, and a right-rear view video of the vehicle.

According to various example embodiments, the operating of the first mode (operation 730) may be executed immediately after the vehicle stops, if a preset period of time elapses from a point in time at which the vehicle stops, if the vehicle starts after stopping, if a speed of the vehicle decreases to be less than a predetermined threshold, or if the speed of the vehicle decreases to be less than the threshold and then increases to be greater than or equal to the threshold.

According to various example embodiments, the performing of the first mode (operation 730) may include acquiring the surrounding videos through the plurality of camera devices 110, respectively (operation 830, 930), generating the split screen 310, 510 by arranging the surrounding videos in a preset array (operation 840, 943), and displaying the split screen 310, 510 through the digital rear mirror 120 (operation 850, 950).

According to various example embodiments, the performing of the first mode (operation 730) may be executed after switching digital rear mirror 120 to a display state (operation 820, 920), if the digital rear mirror 120 is in a mirror state (operation 810, 910).

According to various example embodiments, the performing of the second mode (operation 760) may be executed if the vehicle starts, if a preset speed is reached after starting the vehicle, or if a preset period of time elapses after starting the vehicle.

According to various example embodiments, the performing of the second mode (operation 760) may include driving the digital rear mirror 120 in the mirror state (operation 1030).

According to various example embodiments, the performing of the second mode (operation 760) may include displaying at least one surrounding video of the vehicle through the digital rear mirror 120 (operations 1040 and 1050).

According to various example embodiments, an operating method of the electronic device 130 may further include determining stopping of the vehicle and driving of the vehicle, and the state information may include at least one of speed information, operation information of a brake pedal, operation information of an accelerator pedal, and location information.

According to some example embodiments, the performing of the first mode (operation 730) may include recognizing a predetermined object in at least one of surrounding videos (operation 941), and outputting information on the object while displaying the split screen 510 through the digital rear mirror 120 (operation 950).

According to some example embodiments, the operating of the information on the object (operation 950) may include at least one of displaying an indicator representing information on the object within the split screen 510 and outputting an audio signal representing information on the object.

According to some example embodiments, the object may include at least one of a person, a thing, a thing approaching the vehicle, and a thing moving away from the vehicle.

According to some example embodiments, information on the object may include at least one of the object's type, size, speed, and distance from the vehicle.

In the present disclosure, the electronic device 130 mounted to the vehicle may include the memory 660, and the processor 670 configured to connect to the memory 660 and to execute at least one instruction stored in the memory 660, and the processor 670 may perform a first mode of displaying surrounding videos of the vehicle in the split screen 310, 510 through the digital rear mirror 120 of the vehicle based on a motion related to stopping of the vehicle and to perform a preset second mode through the digital rear mirror 120 while driving the vehicle.

According to various example embodiments, the surrounding videos may include at least two of a front view video, a front-rear view video, a left-rear view video, and a right-rear view video of the vehicle.

According to various example embodiments, the processor 670 may be configured to perform the first mode immediately after the vehicle stops, if a preset period of time elapses from a point in time at which the vehicle stops, if the vehicle starts after stopping, if a speed of the vehicle decreases to be less than a predetermined threshold, or if the speed of the vehicle decreases to be less than the threshold and then increases to be greater than or equal to the threshold.

According to various example embodiments, in the first mode, the processor 670 may be configured to acquire the surrounding videos through the plurality of camera devices 110, respectively, to generate the split screen 310, 510 by arranging the surrounding videos in a preset array, and to display the split screen 310, 510 through the digital rear mirror 120.

According to various example embodiments, if the digital rear mirror 120 is in a mirror state, the processor 670 may be configured to perform the first mode after switching the digital rear mirror 120 to a display state.

According to various example embodiments, the processor 670 may be configured to perform the second mode if the vehicle starts, if a preset speed is reached after starting the vehicle, or if a preset period of time elapses after starting the vehicle.

According to various example embodiments, in the second mode, the processor 670 may be configured to drive the digital rear mirror 120 in the mirror state.

According to various example embodiments, in the second mode, the processor 670 may be configured to display at least one surrounding video of the vehicle through the digital rear mirror 120.

According to various example embodiments, the processor 670 may be configured to determine stopping of the vehicle and driving of the vehicle using state information of the vehicle, and the state information may include at least one of speed information, operation information of a brake pedal, operation information of an accelerator pedal, and location information.

According to some example embodiments, in the first mode, the processor 670 may be configured to recognize a predetermined object in at least one of the surrounding videos, and to output information on the object while displaying the split screen 510 through the digital rear mirror 120.

According to some example embodiments, the processor 670 may be configured to perform at least one of indicating an indicator representing information on the object within the split screen 510 and outputting an audio signal representing information on the object.

According to some example embodiments, the object may include at least one of a person, a thing, a thing approaching the vehicle, and a thing moving away from the vehicle.

According to some example embodiments, information on the object may include at least one of the object's type, size, speed, and distance from the vehicle.

In the present disclosure, the video processing system 100 mounted to the vehicle may include the plurality of camera devices 110 configured to capture the surrounding videos of the vehicle, respectively, the electronic device 130 configured to communicatively connect to the camera devices 110 and to process the surrounding videos, and the digital rear mirror 120 configured to communicatively connect to the electronic device 130 and to display video information from the electronic device 130, and the electronic device 130 may be configured to perform the first mode of displaying the surrounding videos of the vehicle in the split screen 310, 510 through the digital rear mirror 120 of the vehicle based on the motion related to stopping of the vehicle and to perform the preset second mode through the digital rear mirror 120 while driving the vehicle.

According to some example embodiments, in the first mode, the electronic device 130 may be configured to recognize a predetermined object in at least one of the surrounding videos, and to output information on the object while displaying the split screen 510 through the digital rear mirror 120.

In an example embodiment, the electronic device 130 and the digital rear mirror 120 may be integrally configured, and may be provided within the driver's front view range in the vehicle.

In another example embodiment, the electronic device 130 and the digital rear mirror 120 may be separately configured, and the digital rear mirror 120 may be provided within the driver's front view range in the vehicle.

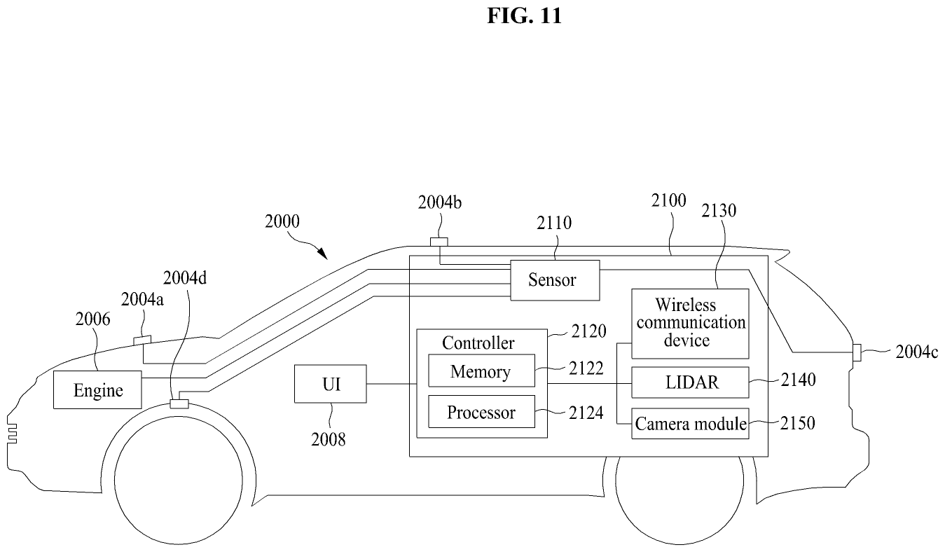

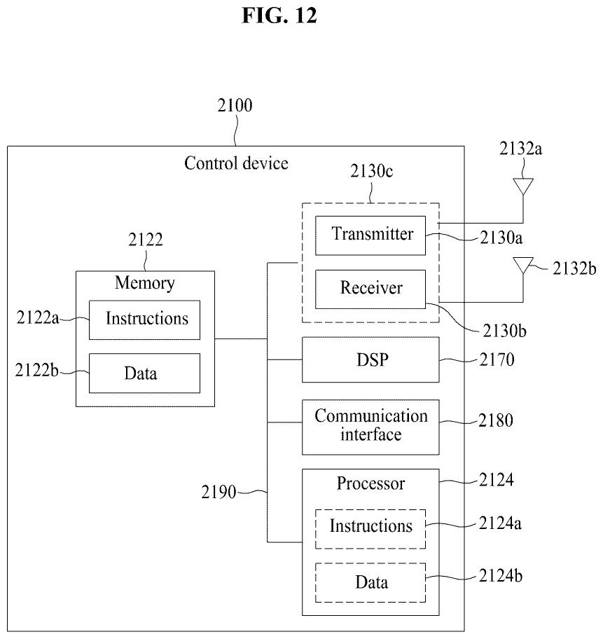

FIG. 11 is a block diagram illustrating a vehicle 2000 to which the video processing system 100 is mounted according to various example embodiments. FIG. 12 is a block diagram illustrating a control device 2100 of the vehicle of FIG. 11.

Referring to FIGS. 11 and 12, the video processing system 100 according to various example embodiments may be mounted to the vehicle 2000 and the vehicle 2000 may include the control device 2100. Here, the vehicle 2000 may be an autonomous vehicle. In some example embodiments, at least one component of the video processing system 100 may be integrated into at least one component of the control device 2100.

The control device 2100 may include a controller 2120 that includes a memory 2122 and a processor 2124, a sensor 2110, a wireless communication device 2130, a LiDAR device 2140, and a camera module 2150.

The controller 2120 may be configured at a time of manufacture by a manufacturing company of the vehicle or may be additionally configured to perform an autonomous driving function after manufacture. Alternatively, a configuration to continuously perform an additional function by upgrading the controller 2120 configured at the time of manufacture may be included.

The controller 2120 may forward a control signal to the sensor 2110, an engine 2006, a user interface (UI) 2008, the wireless communication device 2130, the LIDAR device 2140, and the camera module 2150 included as other components in the vehicle. Also, although not illustrated, the controller 2120 may forward a control signal to an acceleration device, a braking system, a steering device, or a navigation device associated with driving of the vehicle.

The controller 2120 may control the engine 2006. For example, the controller 2120 may sense a speed limit of a road on which the vehicle 2000 is driving and may control the engine 2006 such that a driving speed may not exceed the speed limit, or may control the engine 2006 to increase the driving speed of the vehicle 2000 within the range of not exceeding the speed limit. Additionally, when sensing modules 2004a, 2004b, 2004c, and 2004d sense an external environment of the vehicle and forward the same to the sensor 2110, the controller 2120 may receive external environment information, may generate a signal for controlling the engine 2006 or a steering device (not shown), and thereby control driving of the vehicle.

When another vehicle or an obstacle is present in front of the vehicle, the controller 2120 may control the engine 2006 or the braking system to decrease the driving speed and may also control a trajectory, a driving route, and a steering angle in addition to the speed. Alternatively, the controller 2120 may generate a necessary control signal according to recognition information of other external environments, such as, for example, a driving lane, a driving signal, etc., of the vehicle, and may control driving of the vehicle.

The controller 2120 may also control driving of the vehicle by communicating with a nearby vehicle or a central server in addition to autonomously generating the control signal and by transmitting an instruction for controlling peripheral devices based on the received information.

Further, if a location or an angle of view of the camera module 2150 is changed, it may be difficult for the controller 2120 to accurately recognize a vehicle or a lane. To prevent this, the controller 2120 may generate a control signal for controlling a calibration of the camera module 2150. Therefore, the controller 2120 may generate a calibration control signal for the camera module 2150 and may continuously maintain a normal mounting location, direction, angle of view, etc., of the camera module 2150 regardless of a change in a mounting location of the camera module 2150 by a vibration or an impact occurring due to a motion of the autonomous vehicle 2000. When prestored information on an initial mounting location, direction, and angle of view of the camera module 2120 differs from information on the initial mounting location, direction, and angle of view of the camera module 2120 that are measured during driving of the autonomous vehicle 2000 by a threshold or more, the controller 2120 may generate a control signal for performing calibration of the camera module 2120.

The controller 2120 may include the memory 2122 and the processor 2124. The processor 2124 may execute software stored in the memory 2122 in response to the control signal of the controller 2120. In detail, the controller 2120 may store, in the memory 2122, data and instructions for detecting a visual field view from a rear view video of the vehicle 2000, and the instructions may be executed by the processor 2124 to perform one or more methods disclosed herein.

Here, the memory 2122 may be stored in a recording medium executable at the non-volatile processor 2124. The memory 2122 may store software and data through an appropriate external device. The memory 2122 may include random access memory (RAM), read only memory (ROM), hard disk, and a memory device connected to a dongle.

The memory 2122 may at least store an operating system (OS), a user application, and executable instructions. The memory 2122 may store application data and arrangement data structures.

The processor 2124 may be a controller, a microcontroller, or a state machine as a microprocessor or an appropriate electronic processor.

The processor 2124 may be configured as a combination of computing devices. The computing device may be configured as a digital signal processor, a microprocessor, or an appropriate combination thereof.

Also, the control device 2100 may monitor internal and external features of the vehicle 2000 and may detect a state of the vehicle 2000 using at least one sensor 2110.

The sensor 2110 may include at least one sensing module 2004. The sensing module 2004 may be implemented at a specific location of the vehicle 2000 depending on a sensing purpose. The sensing module 2004 may be provided in a lower portion, a rear end, a front end, an upper end, or a side end of the vehicle 2000 and may be provided to an internal part of the vehicle, a tier, and the like.

Through this, the sensing module 2004 may sense driving information, such as the engine 2006, a tier, a steering angle, a speed, a vehicle weight, and the like, as internal vehicle information. Also, the at least one sensing module 2004 may include an acceleration sensor (2110), a gyroscope, an image sensor (2110), a radar, an ultrasound sensor, a LiDAR sensor, and the like, and may sense motion information of the vehicle 2000.

The sensing module 2004 may receive specific data, such as state information of a road on which the vehicle 2000 is present, nearby vehicle information, and an external environmental state such as weather, as external information, and may sense a vehicle parameter according thereto. The sensed information may be stored in the memory 2122 temporarily or in long-term depending on purposes.

The sensor 2110 may integrate and collect information of the sensing modules 2004 for collecting information generated inside and on outside the vehicle 2000.

The control device 2100 may further include the wireless communication device 2130.

The wireless communication device 2130 is configured to implement wireless communication between the vehicles 2000. For example, the wireless communication device 2130 enables the vehicles 2000 to communicate with a mobile phone of a user, another wireless communication device 2130, another vehicle, a central device (traffic control device), a server, and the like. The wireless communication device 2130 may transmit and receive a wireless signal according to a connection communication protocol. A wireless communication protocol may be WiFi, Bluetooth, Long-Term Evolution (LTE), code division multiple access (CDMA), wideband code division multiple access (WCDMA), and global systems for mobile communications (GSM). However, it is provided as an example only and the wireless communication protocol is not limited thereto.

Also, the vehicle 2000 may implement vehicle-to-vehicle (V2V) communication through the wireless communication device 2130. That is, the wireless communication device 2130 may perform communication with another vehicle and other vehicles on the roads through the V2V communication. The vehicle 2000 may transmit and receive information, such as driving warnings and traffic information, through the V2V communication and may also request another vehicle for information or may receive a request from the other vehicle. For example, the wireless communication device 2130 may perform the V2V communication using a dedicated short-range communication (DSRC) device or a cellular-V2V (CV2V) device. Also, in addition to the V2V communication, vehicle-to-everything (V2X) communication, communication between the vehicle and another object (e.g., electronic device carried by pedestrian), may be implemented through the wireless communication device 2130.

Also, the control device 2100 may include the LIDAR device 2140. The LIDAR device 2140 may detect an object around the vehicle 2000 during an operation, based on data sensed using a LIDAR sensor. The LIDAR device 2140 may transmit detection information to the controller 2120, and the controller 2120 may operate the vehicle 2000 based on the detection information. For example, when the detection information includes a vehicle ahead driving at a low speed, the controller 2120 may instruct the vehicle to decrease a speed through the engine 2006. Alternatively, the controller 2120 may instruct the vehicle to decrease a speed based on a curvature of a curve the vehicle enters.

The control device 2100 may further include the camera module 2150. The controller 2120 may extract object information from an external image captured from the camera module 2150, and may process the extracted object information using the controller 2120.

Also, the control device 2100 may further include imaging devices configured to recognize an external environment. In addition to the LIDAR device 2140, a radar, a GPS device, a driving distance measurement device (odometry), and other computer vision devices may be used. Such devices may selectively or simultaneously operate depending on necessity, thereby enabling further precise sensing.

The vehicle 2000 may further include the user interface (UI) 2008 for a user input to the control device 2100. The user interface 2008 enables the user to input information through appropriate interaction. For example, the user interface 2008 may be configured as a touchscreen, a keypad, and a control button. The user interface 2008 may transmit an input or an instruction to the controller 2120, and the controller 2120 may perform a vehicle control operation in response to the input or the instruction.

Also, the user interface 2008 may enable communication between an external device of the vehicle 2000 and the vehicle 2000 through the wireless communication device 2130. For example, the user interface 2008 may enable interaction with a mobile phone, a tablet, or other computer devices.

Further, although the example embodiment describes that the vehicle 2000 includes the engine 2006, it is provided as an example only. The vehicle 2000 may include a different type of a propulsion system. For example, the vehicle 2000 may run with electric energy, and may run with hydrogen energy or through a hybrid system with a combination thereof. Therefore, the controller 2120 may include a propulsion mechanism according to the propulsion system of the vehicle 2000 and may provide a control signal according thereto to each component of the propulsion mechanism.

Hereinafter, a configuration of the control device 2100 of the vehicle 2000 is described with reference to FIG. 12.

The control device 2100 may include the processor 2124. The processor 2124 may be a general-purpose single or multi-chip microprocessor, a dedicated microprocessor, a microcontroller, a programmable gate array, and the like. The processor 2124 may also be referred to as a central processing unit (CPU). Also, the processor 2124 may be a combination of a plurality of processors.

The control device 2100 also includes the memory 2122. The memory 2122 may be any electronic component capable of storing electronic information. The memory 2122 may include a combination of memories 2122 in addition to a unit memory.

According to various example embodiments, data and instructions 2122a of the vehicle 2000 may be stored in the memory 2122. When the processor 2124 executes the instructions 2122a, the instructions 2122a and a portion or all of the data 2122b required to perform command may be loaded to the processor 2124 (2124a and 2124b).

The control device 2100 may include a transmitter 2130a and a receiver 2130b, or a transceiver 2130c, to allow transmission and reception of signals. One or more antennas 2132a and 2132b may be electrically connected to the transmitter 2130a and the receiver 2130b, or the transceiver 2130c, and may include additional antennas.

The control device 2100 may include a digital signal processor (DSP) 2170, and may control the vehicle to quickly process a digital signal through the DSP 2170.

The control device 2100 may also include a communication interface 2180. The communication interface 2180 may include one or more ports and/or communication modules configured to connect other devices to the control device 2100. The communication interface 2180 may enable interaction between the user and the control device 2100.

Various components of the control device 2100 may be connected through one or more buses 2190, and the buses 2190 may include a power bus, a control signal bus, a state signal bus, and a database bus. The components may forward mutual information through the buses 2190 under control of the processor 2124 and may perform desired functions.

The apparatuses described herein may be implemented using hardware components, software components, and/or a combination of the hardware components and the software components. For example, the apparatuses and the components described herein may be implemented using one or more general-purpose or special purpose computers, for example, a processor, a controller, an arithmetic logic unit (ALU), a digital signal processor, a microcomputer, a field programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will be appreciated that the processing device may include multiple processing elements and/or multiple types of processing elements. For example, the processing device may include multiple processors or a processor and a controller. In addition, other processing configurations are possible, such as parallel processors.

The software may include a computer program, a piece of code, an instruction, or some combinations thereof, for independently or collectively instructing or configuring the processing device to operate as desired. Software and/or data may be embodied in any type of machine, component, physical equipment, computer storage medium or device, to provide instructions or data to the processing device or be interpreted by the processing device. The software also may be distributed over network coupled computer systems so that the software is stored and executed in a distributed fashion. The software and data may be stored by one or more computer readable storage mediums.

The methods according to various example embodiments may be implemented in a form of a program instruction executable through various computer methods and recorded in computer-readable media. Here, the media may be to continuously store a computer-executable program or to temporarily store the same for execution or download. The media may be various types of record methods or storage methods in which a single piece of hardware or a plurality of pieces of hardware are combined and may be distributed over a network without being limited to a medium that is directly connected to a computer system. Examples of the media include magnetic media such as hard disks, floppy disks, and magnetic tapes; optical media such as CD ROM and DVD; magneto-optical media such as floptical disks; and hardware devices that are specially configured to store and perform program instructions, such as read-only memory (ROM), random access memory (RAM), flash memory, and the like. Examples of other media may include recording media and storage media managed by an app store that distributes applications or a site, a server, and the like that supplies and distributes other various types of software.

Various example embodiments and the terms used herein are not construed to limit description disclosed herein to a specific implementation and should be understood to include various modifications, equivalents, and/or substitutions of a corresponding example embodiment. In the drawings, like reference numerals refer to like components throughout the present specification. The singular forms “a,” “an,” and “the” are intended to include the plural forms as well, unless the context clearly indicates otherwise. Herein, the expressions, “A or B,” “at least one of A and/or B,” “A, B, or C,” “at least one of A, B, and/or C,” and the like may include any possible combinations of listed items. Terms “first,” “second,” etc., are used to describe corresponding components regardless of order or importance and the terms are simply used to distinguish one component from another component. The components should not be limited by the terms. When a component (e.g., first component) is described to be “(functionally or communicatively) connected to” or “accessed to” another component (e.g., second component), the component may be directly connected to the other component or may be connected through still another component (e.g., third component).

The term “module” used herein may include a unit configured as hardware, software, or firmware, and may be interchangeably used with the terms, for example, “logic,” “logic block,” “part,” “circuit,” etc. The module may be an integrally configured part, a minimum unit that performs one or more functions, or a portion thereof. For example, the module may be configured as an application-specific integrated circuit (ASIC).

According to various example embodiments, each of the components (e.g., module or program) may include a singular object or a plurality of objects. According to various example embodiments, at least one of the components or operations may be omitted. Alternatively, at least one another component or operation may be added. Alternatively or additionally, a plurality of components (e.g., modules or programs) may be integrated into a single component. In this case, the integrated component may perform one or more functions of each of the components in the same or similar manner as it is performed by a corresponding component before integration. According to various example embodiments, operations performed by a module, a program, or another component may be performed in a sequential, parallel, iterative, or heuristic manner. Alternatively, at least one of the operations may be performed in different sequence or omitted. Alternatively, at least one another operation may be added.

What is claimed is:

1. An operating method of an electronic device mounted to a vehicle, the operating method comprising:
performing a first mode of displaying surrounding videos of the vehicle in a split screen through a digital rear mirror of the vehicle based on a motion related to stopping of the vehicle; and
performing a preset second mode through the digital rear mirror while driving the vehicle.

2. The operating method of claim 1, wherein the surrounding videos include at least two of a front view video, a front-rear view video, a left-rear view video, and a right-rear view video of the vehicle.

3. The operating method of claim 1, wherein the performing of the first mode is executed,
immediately after the vehicle stops,
if a preset period of time elapses from a point in time at which the vehicle stops,
if the vehicle starts after stopping,
if a speed of the vehicle decreases to be less than a predetermined threshold, or
if the speed of the vehicle decreases to be less than the threshold and then increases to be greater than or equal to the threshold.

4. The operating method of claim 1, wherein the performing of the first mode comprises:
acquiring the surrounding videos through a plurality of camera devices, respectively;
generating the split screen by arranging the surrounding videos in a preset array; and
displaying the split screen through the digital rear mirror.

5. The operating method of claim 1, wherein the performing of the first mode is executed after switching the digital rear mirror to a display state if the digital rear mirror is in a mirror state.

6. The operating method of claim 1, wherein the performing of the second mode is executed,
if the vehicle starts,
if a preset speed is reached after starting the vehicle, or
if a preset period of time elapses after starting the vehicle.

7. The operating method of claim 1, wherein the performing of the second mode comprises driving the digital rear mirror in a mirror state.

8. The operating method of claim 1, wherein the performing of the second mode comprises displaying at least one surrounding video of the vehicle through the digital rear mirror.

9. The operating method of claim 1, further comprising:
determining stopping of the vehicle and driving of the vehicle using state information of the vehicle,
wherein the state information includes at least one of speed information, operation information of a brake pedal, operation information of an accelerator pedal, and location information.

10. The operating method of claim 1, wherein the performing of the first mode comprises:
recognizing a predetermined object in at least one of the surrounding videos; and
outputting information on the object while displaying the split screen through the digital rear mirror,
the object includes at least one of a person, a thing, a thing approaching the vehicle, and a thing moving away from the vehicle, and
information on the object includes at least one of the object's type, size, speed, and distance from the vehicle.

11. An electronic device mounted to a vehicle, the electronic device comprising:
a memory; and
a processor configured to connect to the memory, and configured to execute at least one instruction stored in the memory,
wherein the processor is configured to,
perform a first mode of displaying surrounding videos of the vehicle in a split screen through a digital rear mirror of the vehicle based on a motion related to stopping of the vehicle, and
perform a preset second mode through the digital rear mirror while driving the vehicle.

12. The electronic device of claim 11, wherein the surrounding videos include at least two of a front view video, a front-rear view video, a left-rear view video, and a right-rear view video of the vehicle.

13. The electronic device of claim 11, wherein the processor is configured to perform the first mode,
immediately after the vehicle stops,
if a preset period of time elapses from a point in time at which the vehicle stops,
if the vehicle starts after stopping,
if a speed of the vehicle decreases to be less than a predetermined threshold, or
if the speed of the vehicle decreases to be less than the threshold and then increases to be greater than or equal to the threshold.

14. The electronic device of claim 11, wherein, in the first mode, the processor is configured to,
acquire the surrounding videos through a plurality of camera devices, respectively,
generate the split screen by arranging the surrounding videos in a preset array, and
display the split screen through the digital rear mirror.

15. The electronic device of claim 11, wherein, if the digital rear mirror is in a mirror state, the processor is configured to perform the first mode after switching the digital rear mirror to a display state.

16. The electronic device of claim 11, wherein the processor is configured to perform the second mode,
if the vehicle starts,
if a preset speed is reached after starting the vehicle, or
if a preset period of time elapses after starting the vehicle.

17. The electronic device of claim 11, wherein, in the second mode, the processor is configured to drive the digital rear mirror in a mirror state.

18. The electronic device of claim 11, wherein, in the second mode, the processor is configured to display at least one surrounding video of the vehicle through the digital rear mirror.

19. The electronic device of claim 11, wherein the processor is configured to determine stopping of the vehicle and driving of the vehicle using state information of the vehicle, and
the state information includes at least one of speed information, operation information of a brake pedal, operation information of an accelerator pedal, and location information.

20. The electronic device of claim 11, wherein, in the first mode, the processor is configured to,
recognize a predetermined object in at least one of the surrounding videos, and
output information on the object while displaying the split screen through the digital rear mirror,
the object includes at least one of a person, a thing, a thing approaching the vehicle, and a thing moving away from the vehicle, and
information on the object includes at least one of the object's type, size, speed, and distance from the vehicle.
